(19) United States
(12) Patent Application Publication
(10) Pub. No.: US 2025/0005268 A1
(43) Pub. Date: Jan. 2, 2025

(54) INFORMATION PROCESSING METHOD AND APPARATUS, TERMINAL, AND STORAGE MEDIUM

(71) Applicant: Beijing Zitiao Network Technology Co., Ltd., Beijing (CN)

(72) Inventors: Xiaonan BAI, Beijing (CN); Kun TONG, Beijing (CN); Song WANG, Beijing (CN); Dapeng CAO, Beijing (CN); Yu DENG, Beijing (CN); Ziyan LI, Beijing (CN); Kai DU, Beijing (CN); Yifan DING, Beijing (CN); Xiaojun YOU, Beijing (CN); Ji LI, Beijing (CN)

(21) Appl. No.: 18/711,323

(22) PCT Filed: Nov. 17, 2022
(86) PCT No.: PCT/CN2022/132620

§ 371 Date: May 17, 2024

(30) Foreign Application Priority Data
Nov. 17, 2021 (CN) 202111362844.7

(51) Int. Cl. G06F 40/169; G06F 40/197

(52) U.S. Cl. CPC G06F 40/169; G06F 40/197

(57) ABSTRACT

The present disclosure provides an information processing method and apparatus, a terminal, and a storage medium. The information processing method includes: receiving a first document, and generating a second document based on the first document; establishing an association relationship between the second document and at least one associated person, and displaying the association relationship in a first associated area of a content area of the second document; and receiving an edit operation performed by the associated person on the content area of the second document, and generating editing information in a second associated area of the content area of the second document based on the edit operation.

### CROSS-REFERENCE TO RELATED APPLICATION

The present application is filed based on and claims priority to Chinese Patent Application No. 202111362844.7, filed on Nov. 17, 2021 and entitled “INFORMATION PROCESSING METHOD AND APPARATUS, TERMINAL, AND STORAGE MEDIUM”, which is incorporated herein by reference in its entirety.

### TECHNICAL FIELD

The present disclosure relates to the field of information technologies, and in particular, to an information processing method and apparatus, a terminal, and a storage medium.

### BACKGROUND

Before a contract is signed, the teams of both parties usually need to communicate and discuss content of the contract to ultimately ensure that both parties reach an agreement on the content of the contract. During a contract discussion process, both parties usually communicate through phone calls, emails, or some social software to confirm the content of the contract.

### SUMMARY

In order to solve the existing problems, the present disclosure provides an information processing method and apparatus, a terminal, and a storage medium.

The present disclosure uses the following technical solutions.

An embodiment of the present disclosure provides an information processing method, including: receiving a first document, and generating a second document based on the first document; establishing an association relationship between the second document and at least one associated person, and displaying the association relationship in a first associated area of a content area of the second document; and receiving an edit operation performed by the associated person on the content area of the second document, and generating editing information in a second associated area of the content area of the second document based on the edit operation.

Another embodiment of the present disclosure provides an information processing apparatus, including: a document receiving module configured to receive a first document, and generate a second document based on the first document; a relationship establishing module configured to establish an association relationship between the second document and at least one associated person, and display the association relationship in a first associated area of a content area of the second document; and an editing module configured to receive an edit operation performed by the associated person on the content area of the second document, and generate editing information in a second associated area of the content area of the second document based on the edit operation.

In some embodiments, the present disclosure provides a terminal, including: at least one memory and at least one processor, where the memory is configured to store program code, and the processor is configured to invoke the program code stored in the memory, to perform the information processing method as described above.

In some embodiments, the present disclosure provides a storage medium configured to store program code, the program code being used to perform the information processing method as described above.

In the embodiments of the present disclosure, establishing the association relationship between the second document and the at least one associated person enables the associated person to perform the edit operation on the second document and corresponding editing information to be generated. In this way, multiple people are allowed to edit the second document online, so that the editing and confirmation of the second document can be performed online and synchronously, and traces of editing can be retained for later reference, which greatly facilitates communication and confirmation of the document.

### BRIEF DESCRIPTION OF DRAWINGS

The foregoing and other features, advantages, and aspects of embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale.

FIG. 1 is a flowchart of an information processing method according to an embodiment of the present disclosure;

FIG. 2 to FIG. 5 are schematic diagrams of a second document according to some embodiments;

FIG. 6 shows some modules of an information processing apparatus according to some embodiments of the present disclosure; and

FIG. 7 is a schematic diagram of a structure of an electronic device according to an embodiment of the present disclosure.

### DETAILED DESCRIPTION

Embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifier “a/an” mentioned in the present disclosure is illustrative and not restrictive, and those skilled in the art should understand that unless the context clearly indicates otherwise, the modifier should be understood as “one or more”.

The names of messages or information exchanged between a plurality of apparatuses in the implementations of the present disclosure are used for illustrative purposes only, and are not used to limit the scope of these messages or information.

The current contract negotiation process is substantially asynchronous and offline, and it is impossible to know content modified by and a modification status of each collaborator in a timely manner.

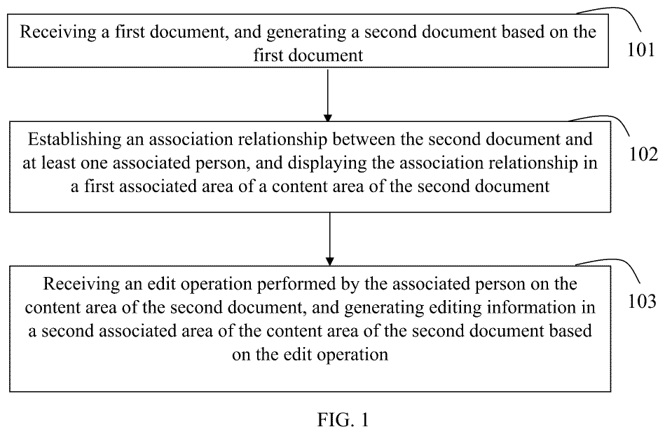

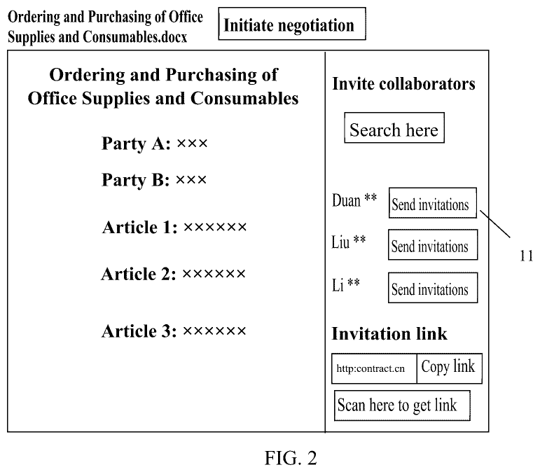

FIG. 1 is a flowchart of an information processing method according to an embodiment of the present disclosure. The information processing method of the present disclosure may include step 101 of receiving a first document, and generating a second document based on the first document. In some embodiments, a document type of the first document includes, but is not limited to, a local document, an electronic document, an online document, or the like. In some embodiments, the second document includes, but is not limited to, a document capable of being collaborated on by multiple people, such as an electronic document or an online document. For example, a system may locally receive the first document (for example, a Word document), and generate, based on the first document, an online document capable of being collaborated on by multiple people. As an example, FIG. 2 is a schematic diagram of a second document according to some embodiments, where the second document is generated based on the first document “Ordering and Purchasing of Office Supplies and Consumables”.

In some embodiments, a page of establishing an association relationship with an associated person is displayed in response to the document type of the first document or the second document being a preset document type; and a form page for filling in document information of the first document or the second document is displayed in response to the document type of the first document or the second document being not the preset document type. The preset document type may be a type such as doc, docx, or pdf.

In some embodiments, the method of the present disclosure may further include step 102 of establishing an association relationship between the second document and at least one associated person, and displaying the association relationship in a first associated area 11 of a content area of the second document. In some embodiments, the associated person includes a collaboration initiator and a collaboration participant. In some embodiments, the collaboration initiator may be an associated person who uploads the first document to the system. In some embodiments, both the collaboration initiator and the collaboration participant may perform an edit operation on the generated second document.

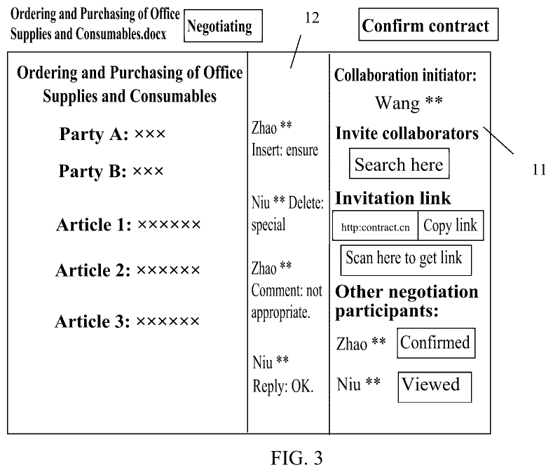

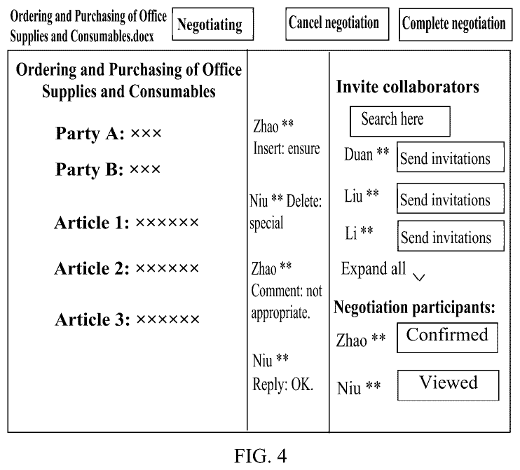

In some embodiments, the method of the present disclosure may further include step 103 of receiving an edit operation performed by the associated person on the content area of the second document, and generating editing information in a second associated area 12 of the content area of the second document based on the edit operation. As shown in FIG. 3, in some embodiments, during collaboration, the second document may be subjected to the edit operation (for example, insertion, deletion, etc.), and the editing information is generated in the second associated area 12 to indicate which modifications have been made to the second document.

In some embodiments, the edit operation includes a modify operation and a comment operation; and the generating editing information in a second associated area of the content area of the second document based on the edit operation includes: generating corresponding editing information in the second associated area of the content area of the second document based on the modify operation or the comment operation.

In some embodiments, the editing information in the second associated area is presented in the form of card information. The editing information includes two types: content information and comment information. The content information is information about modifications made by users to the content, and the comment information is information about comments made by users on the content. The content information includes a user identifier, a time identifier, and/or operation information, and the operation information includes an operation type and operation content; and the comment information includes a user identifier, a time identifier, and/or comment content. The user identifier includes at least one of a name, a department, and an avatar.

In this embodiment of the present disclosure, the association relationship between the second document and the at least one associated person is established, so that the associated person can perform the edit operation on the second document, and corresponding editing information is generated. In this way, multiple people are allowed to edit the second document online, so that the editing and confirmation of the second document can be performed online and synchronously, and traces of editing can be retained throughout the entire process for later reference, which greatly facilitates communication and confirmation of the document.

In some embodiments, as shown in FIG. 2, before the establishing an association relationship between the second document and at least one associated person, the method includes: displaying person recommendation information, a person search control, and/or a share control in the first associated area 11 of the content area of the second document. Therefore, in this embodiment of the present disclosure, the system may recommend some collaboration participants to the collaboration initiator or collaboration participant of the second document, for example, may recommend superior and subordinate colleagues of and colleagues in the same department of the collaboration initiator or participant, etc. In some embodiments, it is also possible for the collaboration initiator or collaboration participant to search for a related person and send a participation invitation to the person. In some embodiments, it is also possible to obtain an invitation link by copying the invitation link or scanning a code, and then send a participation invitation to a corresponding person. As shown in FIG. 2, the person recommendation information, the person search control, and/or the share control are displayed in the first associated area 11 of the content area of the second document. Therefore, the embodiments of the present disclosure provide a plurality of convenient ways to invite collaboration participants.

In some embodiments, the displaying the association relationship in a first associated area 11 of a content area of the second document includes: displaying identity information and editing stage information of the associated person. In some embodiments, the identity information may include user avatar information, a user name, a department, etc. In some embodiments, the editing stage information is used to indicate the progress of processing the second document by the associated person. For example, as shown in FIG. 3, the editing stage information may include Confirmed and Viewed. Confirmed indicates that the collaboration participant has no comments on the second document and the processing of the second document has been completed. Viewed indicates that the collaboration participant has viewed the second document and currently processes the document. In this way, each associated person can clearly know the processing progress of the corresponding associated person, which facilitates timely advancement of the negotiation and confirmation of the second document.

In some embodiments, the editing stage information is changed from first editing stage information to second editing stage information in response to a view operation performed by the associated person on the second document. For example, the first editing stage information is Not viewed, and the second editing stage information is Viewed. In some embodiments, the editing stage information is changed from second editing stage information to third editing stage information in response to a trigger operation performed by the associated person on a preset control in the second document. For example, as shown in FIG. 3, when the associated person clicks a “Confirm contract” control, the editing stage information is changed from Viewed to Confirmed, indicating that the negotiation performed by the associated person on the second document has been completed.

In some embodiments, in response to the trigger operation performed by the associated person on the preset control in the second document, it is determined whether the associated person is the initiator of establishing the association relationship. If the associated person is the initiator of establishing the association relationship, the second document is placed in a third editing stage; or if the associated person is not the initiator of establishing the association relationship, the second document is refused to be placed in a third editing stage. The third editing stage is a stage of ending the collaboration.

In some embodiments, in response to the trigger operation performed by the associated person on the preset control in the second document, it is determined whether the associated person is the initiator of establishing the association relationship. If the associated person is the initiator of establishing the association relationship, it is determined whether the current second document has received the edit operation from the associated person; and if the edit operation is received, first prompt information is displayed; or if no edit operation is received, second prompt information is displayed. If the associated person is not the initiator of establishing the association relationship, the second document is refused to be placed in the third editing stage. The third editing stage is a stage of ending the collaboration, and the second document cannot be edited in this stage.

In some embodiments, in the above implementation, regardless of whether the edit operation is received, in addition to displaying the first prompt information or the second prompt information, a confirmation control and a cancel control are displayed; after the confirmation control is clicked, a clean version of the second document is generated and saved and the form page is displayed, the form page being used to fill in the document information of the second document; and after the cancel control is clicked, the prompt information is closed.

In some embodiments, the editing stage information in different stages has different information content, and the information content includes a display status and identifier content. In some embodiments, the information content may be reflected by color and text content. For example, “Confirmed” and “Viewed” are distinguished by text identifier content. In addition, it is also possible to use different color backgrounds or font colors to reflect different display statuses. In this way, the editing stage information of the corresponding associated person can be more clearly represented.

In some embodiments, a status identifier is displayed in an associated area of a title of the second document, where the status identifier is used to indicate whether the association relationship is established between the second document and the associated person. In some embodiments, a first status identifier, for example, “Initiate negotiation” is displayed in response to the association relationship being not established between the second document and the associated person. In some embodiments, a second status identifier, for example, “Negotiating” is displayed in response to the association relationship being established between the second document and the associated person. For example, as shown in FIG. 2 and FIG. 3, the status identifiers “Initiate negotiation” and “Negotiating” may be used to indicate whether the association relationship is established between the second document and the associated person. “Initiate negotiation” indicates that the association relationship has not been established with other associated persons for the time being, and “Negotiating” indicates that association relationships have been established with at least some associated persons.

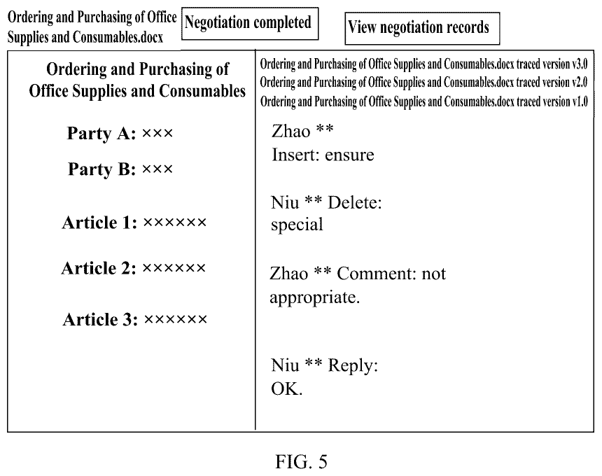

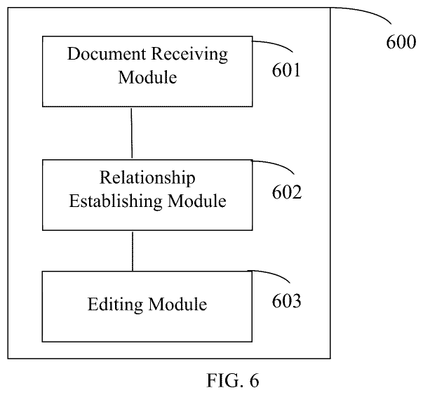

In some embodiments, a third status identifier is displayed in response to the associated person having processed the second document. For example, as shown in FIG. 5, the third status identifier “Negotiation completed” is schematically shown. This indicates that all associated persons have reached an agreement on the content of the second document.

In some embodiments, the edit operation includes a modify operation and/or a comment operation on the content of the second document. That is, the edit operation may be to perform various modifications on the second document, such as inserting, and deleting, or to post comment content. In some embodiments, the editing information includes information (for example, user name) about a user that performs the edit operation and operation content of the edit operation. In some embodiments, the editing information may also include information about time when the edit operation was performed to indicate when the edit operation was performed, so as to facilitate subsequent viewing of the editing history in the revised version of the second document.

In some embodiments, the information processing method of the present disclosure further includes: generating an official version of the second document. After all associated persons have processed the second document, the official version of the second document may be generated. In some embodiments, the generating an official version of the second document includes: generating the official version of the second document based on a preset operation of a preset associated person in the associated person. For example, usually, when the collaboration initiator confirms that the negotiation is completed, the official version of the second document is generated. That is, “Complete negotiation” indicates that the second document has been finalized, and the finalized version is the official version or final version of the second document. In addition, traces may be retained throughout the negotiation of the second document, and negotiation records can be viewed, for example, which revisions were made by which participant at which time.

In some embodiments, generating a historical version based on the second document includes: when receiving a newly uploaded second document, saving the current second document as the historical version; or when the second document enters the third editing stage, saving the second document containing the edit operation as the historical version; or when the second document enters the third editing stage, saving the second document that accepts and clears the edit operation as the historical version. The third editing stage is a stage of ending the collaboration, and the second document cannot be edited in this stage.

In some embodiments, the first document may be a local document, and in some embodiments, the second document may be a document capable of being collaborated on by multiple people, as described above. For example, after the collaboration initiator uploads a local word document to the system, the system may generate, based on the Word document, an online document capable of being collaborated on by multiple people, for negotiation by associated persons.

In some embodiments, a contract is taken as an example to illustrate the negotiation process of the second document. First, the collaboration initiator may upload a first draft of the contract (for example, a Word document) and generate an online document in the system based on the first draft of the contract. Then, a related colleague may be invited to participate in the contract negotiation, for example, through system recommendation, active search user invitation, or through link invitation. Afterwards, the collaboration initiator and the collaboration participant may discuss and edit content of the contract. After completing the contract modification, the collaboration participant may click “Confirm contract”. Then, the collaboration initiator confirms, based on the negotiation status of each associated person, whether the negotiation is completed. After the negotiation is completed, the official version of the contract is generated and is then submitted.

In some embodiments, the initiator of establishing the association relationship may upload a new version of the second document. If the current second document has not received the edit operation from the associated person, in response to the operation to upload a third document by the initiator of establishing the association relationship, the current page is refreshed and the third document is displayed; or if the current second document has received the edit operation from the associated person, in response to the operation to upload a third document by the initiator of establishing the association relationship, an information control interface is displayed, where the information control interface is used to upload or refuse to upload the third document based on the operation by the initiator.

In the embodiments of the present disclosure, the negotiation and modification process of the second document may be completed online, and synchronization can be achieved between various associated persons, which is convenient, efficient, and information transparent. In addition, traces of the negotiation editing process are retained throughout the entire process, for easy traceability. In addition, the system may automatically recommend some related collaboration participants.

An embodiment of the present disclosure further provides an information processing apparatus 600. The information processing apparatus 600 includes a document receiving module 601, a relationship establishing module 602, and an editing module 603. In some embodiments, the document receiving module 601 is configured to receive a first document, and generate a second document based on the first document. In some embodiments, the relationship establishing module 602 is configured to establish an association relationship between the second document and at least one associated person, and display the association relationship in a first associated area of a content area of the second document. In some embodiments, the editing module 603 is configured to receive an edit operation performed by the associated person on the content area of the second document, and generate editing information in a second associated area of the content area of the second document based on the edit operation.

It should be understood that the content described with respect to the information processing method is also applicable to the information processing apparatus 600 here, and will not be described in detail here for the sake of simplicity.

In some embodiments, the relationship establishing module 602 is further configured to, before establishing the association relationship between the second document and the at least one associated person, display person recommendation information, a person search control, and/or a share control in the first associated area of the content area of the second document. In some embodiments, the displaying the association relationship in a first associated area of a content area of the second document includes: displaying identity information and editing stage information of the associated person, the editing stage information being used to indicate the progress of processing the second document by the associated person. In some embodiments, the information processing apparatus 600 further includes a changing module configured to change the editing stage information from first editing stage information to second editing stage information in response to a view operation performed by the associated person on the second document; or change the editing stage information from second editing stage information to third editing stage information in response to a trigger operation performed by the associated person on a preset control in the second document. In some embodiments, the editing stage information in different stages has different information content, and the information content includes a display status and identifier content. In some embodiments, a status identifier is displayed in an associated area of a title of the second document, where the status identifier is used to indicate whether the association relationship is established between the second document and the associated person. In some embodiments, the relationship establishing module 602 is further configured to display a first status identifier in response to the association relationship being not established between the second document and the associated person; or display a second status identifier in response to the association relationship being established between the second document and the associated person. In some embodiments, the changing module is further configured to display a third status identifier in response to the associated person having processed the second document. In some embodiments, the edit operation includes a modify operation and/or a comment operation performed on the content of the second document, and the editing information includes information about a user that performs the edit operation and operation content of the edit operation. In some embodiments, the information processing apparatus 600 further includes an official version generating module configured to generate an official version of the second document, where the generating an official version of the second document includes: generating the official version of the second document based on a preset operation of a preset associated person in the associated person. In some embodiments, the first document is a local document, and the second document is a document capable of being collaborated on by multiple people.

In addition, the present disclosure further provides a terminal, including: at least one memory and at least one processor, where the memory is configured to store program code, and the processor is configured to invoke the program code stored in the memory, to perform the information processing method as described above.

In addition, the present disclosure further provides a computer storage medium having a program code stored therein, the program code being used to perform the information processing method as described above.

The information processing method and apparatus of the present disclosure are described above based on the embodiments and application examples. In addition, the present disclosure further provides a terminal and a storage medium. The terminal and the storage medium are described below.

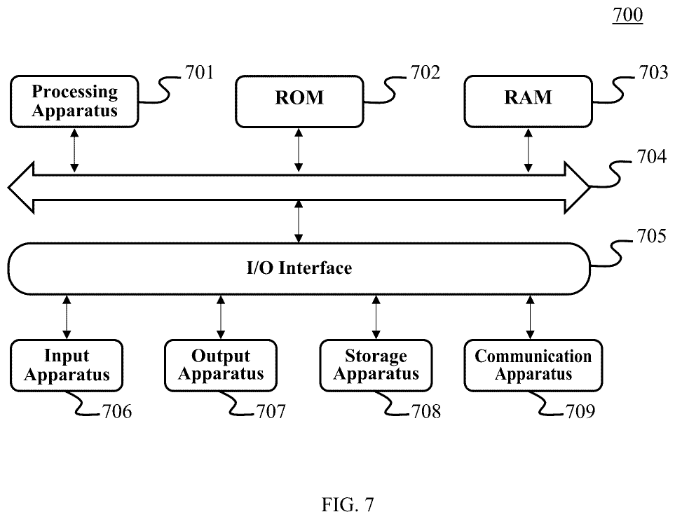

FIG. 7 is a schematic diagram of a structure of an electronic device (e.g., a terminal device or a server) 700 suitable for implementing the embodiments of the present disclosure. The terminal device in this embodiment of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital TV and a desktop computer. The electronic device shown in FIG. 7 is merely an example, and shall not impose any limitation on the function and scope of use of the embodiments of the present disclosure.

As shown in FIG. 7, the electronic device 700 may include a processing apparatus (e.g., a central processing unit, a graphics processing unit, etc.) 701 that may perform a variety of appropriate actions and processing in accordance with a program stored in a read-only memory (ROM) 702 or a program loaded from a storage apparatus 708 into a random-access memory (RAM) 703. The RAM 703 further stores various programs and data required for the operation of the electronic device 700. The processing apparatus 701, the ROM 702, and the RAM 703 are connected to each other through a bus 704. An input/output (I/O) interface 705 is also connected to the bus 704.

Generally, the following apparatuses may be connected to the I/O interface 705: an input apparatus 706 including, for example, a touch screen, a touchpad, a keyboard, a mouse, a camera, a microphone, an accelerometer, a gyroscope, etc.; an output apparatus 707 including, for example, a liquid crystal display (LCD), a speaker, a vibrator, etc.; a storage apparatus 708 including, for example, a tape, a hard disk, etc.; and a communication apparatus 709. The communication apparatus 709 may allow the electronic device 700 to perform wireless or wired communication with other devices to exchange data. Although FIG. 7 shows the electronic device 700 having various apparatuses, it should be understood that it is not required to implement or have all of the shown apparatuses. It may be an alternative to implement or have more or fewer apparatuses.

In particular, according to an embodiment of the present disclosure, the process described above with reference to the flowcharts may be implemented as a computer software program. For example, this embodiment of the present disclosure includes a computer program product, which includes a computer program carried on a computer-readable medium, where the computer program includes program code for performing the method shown in the flowchart. In such an embodiment, the computer program may be downloaded and installed from a network through the communication apparatus 709, or installed from the storage apparatus 708, or installed from the ROM 702. When the computer program is executed by the processing apparatus 701, the above-mentioned functions defined in the method of the embodiment of the present disclosure are performed.

It should be noted that the above computer-readable medium described in the present disclosure may be a computer-readable signal medium, or a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, the client and the server can communicate using any currently known or future-developed network protocol such as a HyperText Transfer Protocol (HTTP), and can be connected to digital data communication (for example, communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs, and the one or more programs, when executed by the electronic device, cause the electronic device to perform the method of the present disclosure as described above.

Computer program code for performing the operations of the present disclosure may be written in one or more programming languages or a combination thereof, where the programming languages include an object-oriented programming language, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the circumstance involving a remote computer, the remote computer may be connected to a computer of a user over any type of network, including a local area network (LAN) or a wide area network (WAN), or may be connected to an external computer (for example, connected over the Internet using an Internet service provider).

The flowcharts and block diagrams in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by means of software, or may be implemented by means of hardware. Names of the units do not constitute a limitation on the units themselves in some cases.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC) system, a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatus, or devices, or any suitable combination thereof. More specific examples of the machine-readable storage medium may include an electrical connection based on one or more wires, a portable computer disk, a hard disk, a random-access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof.

According to one or more embodiments of the present disclosure, an information processing method is provided, including: receiving a first document, and generating a second document based on the first document; establishing an association relationship between the second document and at least one associated person, and displaying the association relationship in a first associated area of a content area of the second document; and receiving an edit operation performed by the associated person on the content area of the second document, and generating editing information in a second associated area of the content area of the second document based on the edit operation.

According to one or more embodiments of the present disclosure, before the establishing an association relationship between the second document and at least one associated person, the method includes: displaying person recommendation information, a person search control, and/or a share control in the first associated area of the content area of the second document.

According to one or more embodiments of the present disclosure, the displaying the association relationship in a first associated area of a content area of the second document includes: displaying identity information and editing stage information of the associated person, the editing stage information being used to indicate the progress of processing the second document by the associated person.

According to one or more embodiments of the present disclosure, the method includes: changing the editing stage information from first editing stage information to second editing stage information in response to a view operation performed by the associated person on the second document; or changing the editing stage information from second editing stage information to third editing stage information in response to a trigger operation performed by the associated person on a preset control in the second document.

According to one or more embodiments of the present disclosure, the editing stage information in different stages has different information content, and the information content includes a display status and identifier content.

According to one or more embodiments of the present disclosure, a status identifier is displayed in an associated area of a title of the second document, the status identifier being used to indicate whether the association relationship is established between the second document and the associated person.

According to one or more embodiments of the present disclosure, the method includes: displaying a first status identifier in response to the association relationship being not established between the second document and the associated person; or displaying a second status identifier in response to the association relationship being established between the second document and the associated person.

According to one or more embodiments of the present disclosure, the method includes: displaying a third status identifier in response to the associated person having processed the second document.

According to one or more embodiments of the present disclosure, the edit operation includes a modify operation and/or a comment operation performed on the content of the second document, and the editing information includes information about a user that performs the edit operation and operation content of the edit operation.

According to one or more embodiments of the present disclosure, the method further includes: generating an official version of the second document, where the generating an official version of the second document includes: generating the official version of the second document based on a preset operation of a preset associated person in the associated person.

According to one or more embodiments of the present disclosure, the first document is a local document, and the second document is a document capable of being collaborated on by multiple people.

According to one or more embodiments of the present disclosure, an information processing apparatus is provided, including: a document receiving module configured to receive a first document, and generate a second document based on the first document; a relationship establishing module configured to establish an association relationship between the second document and at least one associated person, and display the association relationship in a first associated area of a content area of the second document; and an editing module configured to receive an edit operation performed by the associated person on the content area of the second document, and generate editing information in a second associated area of the content area of the second document based on the edit operation.

According to one or more embodiments of the present disclosure, a terminal is provided, including: at least one memory and at least one processor, where the at least one memory is configured to store program code, and the at least one processor is configured to invoke the program code stored in the at least one memory, to perform the method according to any one of the above solutions.

According to one or more embodiments of the present disclosure, a storage medium configured to store program code is provided, the program code being used to perform the method as described above.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should be understood as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. An information processing method, comprising:
receiving a first document, and generating a second document based on the first document;
establishing an association relationship between the second document and at least one associated person, and displaying the association relationship in a first associated area of a content area of the second document; and
receiving an edit operation performed by the associated person on the content area of the second document, and generating editing information in a second associated area of the content area of the second document based on the edit operation.

2. The information processing method according to claim 1, wherein before the establishing an association relationship between the second document and at least one associated person, the method further comprises: displaying person recommendation information, a person search control, and/or a share control in the first associated area of the content area of the second document.

3. The information processing method according to claim 1, wherein the displaying the association relationship in a first associated area of a content area of the second document comprises:
displaying identity information and editing stage information of the associated person, the editing stage information being used to indicate the progress of processing the second document by the associated person.

4. The information processing method according to claim 3, further comprising:
changing the editing stage information from first editing stage information to second editing stage information in response to a view operation performed by the associated person on the second document; or
changing the editing stage information from second editing stage information to third editing stage information in response to a trigger operation performed by the associated person on a preset control in the second document.

5. The information processing method according to claim 4, wherein the editing stage information in different stages has different information content, and the information content comprises a display status and identifier content.

6. The information processing method according to claim 1, wherein a status identifier is displayed in an associated area of a title of the second document, and the status identifier is used to indicate whether the association relationship is established between the second document and the associated person.

7. The information processing method according to claim 6, further comprising:
displaying a first status identifier in response to the association relationship being not established between the second document and the associated person; or
displaying a second status identifier in response to the association relationship being established between the second document and the associated person.

8. The information processing method according to claim 6, further comprising:
displaying a third status identifier in response to the associated person having processed the second document.

9. The information processing method according to claim 1, wherein the edit operation comprises a modify operation and/or a comment operation performed on the content of the second document, and the editing information comprises information about a user that performs the edit operation and operation content of the edit operation.

10. The information processing method according to claim 1, further comprising generating an official version of the second document,
wherein the generating an official version of the second document comprises:
generating the official version of the second document based on a preset operation of a preset associated person in the associated person.

11. The information processing method according to claim 1, wherein the first document is a local document, and the second document is a document capable of being collaborated on by multiple people.

12. An information processing apparatus, comprising:
a document receiving module, configured to receive a first document, and generate a second document based on the first document;
a relationship establishing module, configured to establish an association relationship between the second document and at least one associated person, and display the association relationship in a first associated area of a content area of the second document; and
an editing module, configured to receive an edit operation performed by the associated person on the content area of the second document, and generate editing information in a second associated area of the content area of the second document based on the edit operation.

13. A terminal, comprising:
at least one memory and at least one processor,
wherein the at least one memory is configured to store program code, the at least one processor is configured to invoke the program code stored in the at least one memory, to perform an information processing method, and the information processing method comprises:
receiving a first document, and generating a second document based on the first document;
establishing an association relationship between the second document and at least one associated person, and displaying the association relationship in a first associated area of a content area of the second document; and
receiving an edit operation performed by the associated person on the content area of the second document, and generating editing information in a second associated area of the content area of the second document based on the edit operation.

14. A storage medium configured to store program code, the program code being used to perform the information processing method according to claim 1.

15. The terminal according to claim 13, wherein before the establishing an association relationship between the second document and at least one associated person, the method further comprises: displaying person recommendation information, a person search control, and/or a share control in the first associated area of the content area of the second document.

16. The terminal according to claim 13, wherein the displaying the association relationship in a first associated area of a content area of the second document comprises:
displaying identity information and editing stage information of the associated person, the editing stage information being used to indicate the progress of processing the second document by the associated person.

17. The terminal according to claim 16, wherein the information processing method further comprises:
changing the editing stage information from first editing stage information to second editing stage information in response to a view operation performed by the associated person on the second document; or
changing the editing stage information from second editing stage information to third editing stage information in response to a trigger operation performed by the associated person on a preset control in the second document.

18. The terminal according to claim 17, wherein the editing stage information in different stages has different information content, and the information content comprises a display status and identifier content.

19. The terminal according to claim 13, wherein a status identifier is displayed in an associated area of a title of the second document, and the status identifier is used to indicate whether the association relationship is established between the second document and the associated person.

20. The terminal according to claim 19, wherein the information processing method further comprises:
displaying a first status identifier in response to the association relationship being not established between the second document and the associated person; or
displaying a second status identifier in response to the association relationship being established between the second document and the associated person.
